(19) United States
(12) Patent Application Publication
(10) Pub. No.: US 2026/0134344 A1
(43) Pub. Date: May 14, 2026

(54) PROCESS AND EQUIPMENT INTEGRATED DIGITAL TWIN METHOD AND SYSTEM

(71) Applicant: Industrial Technology Research Institute, Hsinchu (TW)

(72) Inventors: Yu-Hsiuan Chang, Hsinchu County (TW); Po-Yu Huang, Hsinchu County (TW); Chun-Fang Chen, Hsinchu County (TW)

(73) Assignee: Industrial Technology Research Institute, Hsinchu (TW)

(21) Appl. No.: 18/985,077

(22) Filed: Dec. 18, 2024

(30) Foreign Application Priority Data
Nov. 12, 2024 (TW) 113143304

(51) Int. Cl. G06N 20/00

(52) U.S. Cl. CPC G06N 20/00

(57) ABSTRACT

The process and equipment integrated digital twin method and system provided in the disclosure can simultaneously consider the interaction between the process and equipment. Since information such as equipment health status, process recipe, and quality target affects optimal process parameters, by integrating equipment health prediction and quality prediction, an integrated digital twin model of process and equipment can be established, and using process parameters recommended by the model can simultaneously improve product quality and production line efficiency, enhancing the production competitiveness of manufacturers.

### CROSS-REFERENCE TO RELATED APPLICATION

This application claims the priority benefit of Taiwan application serial No. 113143304, filed on Nov. 12, 2024. The entirety of the above-mentioned patent application is hereby incorporated by reference herein and made a part of this specification.

### TECHNICAL FIELD

The disclosure relates to a digital twin method and system, and particularly relates to a process and equipment integrated digital twin method and system.

### BACKGROUND

In the manufacturing industry, process and equipment are two important links in the production process. Therefore, it is a common practice to use data models to perform equipment fault prediction and process quality optimization. However, process and equipment are two very profound theoretical foundations, so when modeling one of the two factors, the other is usually assumed to be fixed. For example, when performing fault prediction, it is assumed that the future process parameters/recipes remain constant; when performing quality optimization, it is assumed that the equipment health status is similar.

However, in fact, in many manufacturing industry application scenarios, there is a strong interaction between process quality and equipment status. Take the distillation process as an example. The process equipment is mainly a distillation tower, which is formed by many packings. The health of the packings affects the performance of the distillation, and the operation method of the distillation also affects the service life of the packings. Therefore, there is an interactive influence between the process and the equipment. Take the grinding equipment as an example. The equipment is mainly a grinding machine, in which the key part is the grinding roller. The health status of the grinding roller affects the grinding quality, and the grinding operation settings affect the service life of the grinding roller.

Therefore, how to simultaneously consider the process quality and equipment status during the manufacturing process and jointly model and apply the two factors is an important issue.

### SUMMARY

In view of the foregoing, the disclosure provides a process and equipment integrated digital twin method and system, which simultaneously combines two major technologies, prognostics and health management (PHM) and process analysis and optimization (PAO), and process parameters are recommended.

This disclosure provides a process and equipment integrated digital twin method, including: obtaining a process data training data set to train an integrated digital twin model; inputting a model input data into the integrated digital twin model to obtain a model output data; inputting the integrated digital twin model into a temporal dynamic parameter optimization module; performing a dynamic parameter optimization on the integrated digital twin model to output a product quality prediction value, a process parameter recommendation value, and a health indicator prediction value, in which the product quality prediction value, the process parameter recommendation value, and the health indicator prediction value are all temporal; evaluating, by a temporal target evaluation module, whether the product quality prediction value and the health indicator prediction value meet a process production target, if not met, continuing an iteration to perform the dynamic parameter optimization, and outputting the product quality prediction value and the health indicator prediction value of at least one batch executable in a future time interval; and selecting a process recommendation parameter from the product quality prediction value and the health indicator prediction value of the at least one batch.

In an embodiment of the disclosure, in the process and equipment integrated digital twin method, the process data training data set includes at least one process parameter, at least one product quality, and at least one equipment health indicator of the machine or equipment of the process, in which the equipment health indicator is related to a sensor parameter of an equipment health condition or a characteristic obtained through health indicator extraction technology.

In an embodiment of the disclosure, the process in the process and equipment integrated digital twin method includes a recipe information.

In an embodiment of the disclosure, the process and equipment integrated digital twin method further includes: establishing the integrated digital twin model through a machine learning algorithm, in which the integrated digital twin model includes an equipment health condition prediction model and a quality prediction model.

In an embodiment of the disclosure, the machine learning algorithm in the process and equipment integrated digital twin method includes support vector machine (SVM), random forest (RF), and deep neural network (DNN), and is combined with multi-task learning technology for modeling; or the machine learning algorithm is a cascade model based on the actual process flow.

In an embodiment of the disclosure, in the process and equipment integrated digital twin method, the model input data at least includes historical process parameters of a t-th batch, a historical equipment health indicator of a (t-1)-th batch, and historical product qualities of the (t-1)-th batch, and the model output data at least includes product qualities of the t-th batch and equipment health indicators of the t-th batch, in which t is an integer greater than 1.

In an embodiment of the disclosure, in the process and equipment integrated digital twin method, the number of iterations is less than or equal to n times.

In an embodiment of the disclosure, in the process and equipment integrated digital twin method, the optimization algorithm of the dynamic parameter optimization is Bayesian optimization or genetic algorithm.

In an embodiment of the disclosure, in the process and equipment integrated digital twin method, the process production target includes a quality target and a production capacity target.

The disclosure provides a process and equipment integrated digital twin system, including: a storage and a processor. The storage stores multiple modules. The processor is coupled to the storage and configured to: obtain a process data training data set to train the integrated digital twin model; input model input data into the integrated digital twin model to obtain model output data; input the integrated digital twin model into a temporal dynamic parameter optimization module among the multiple modules; perform dynamic parameter optimization on the integrated digital twin model to output a product quality prediction value, a process parameter recommendation value, and a health indicator prediction value, in which the product quality prediction value, the process parameter recommendation value, and the health indicator prediction value are all temporal; evaluate, by a temporal target evaluation module among the multiple modules, whether the product quality prediction value and health indicator prediction value meet a process production target, if not met, continue an iteration to perform the dynamic parameter optimization, and output the product quality prediction value and the health indicator prediction value of at least one batch executable in a future time interval; and select a process recommendation parameter from the product quality prediction value and the health indicator prediction value of the at least one batch.

In an embodiment of the disclosure, in the process and equipment integrated digital twin system, the process data training data set includes at least one process parameter, at least one product quality, and at least one equipment health indicator of the machine or equipment of the process, in which the equipment health indicator is related to a sensor parameter of an equipment health condition or a characteristic obtained through the health indicator extraction technology.

In an embodiment of the disclosure, the process in process and equipment integrated digital twin system includes recipe information.

In an embodiment of the disclosure, in the process and equipment integrated digital twin system, the processor is further configured to: establish the integrated digital twin model through a machine learning algorithm, in which the integrated digital twin model includes an equipment health condition prediction model and a quality prediction model.

In an embodiment of the disclosure, the machine learning algorithm in the process and equipment integrated digital twin system includes support vector machine, random forest, and deep neural network, and is combined with multi-task learning technology for modeling; or the machine learning algorithm is a cascade model based on the actual process flow.

In an embodiment of the disclosure, in the process and equipment integrated digital twin system, the model input data at least includes historical process parameters of a t-th batch, a historical equipment health indicator of a (t-1)-th batch, and historical product qualities of the (t-1)-th batch, and the model output data at least includes product qualities of the t-th batch and equipment health indicators of the t-th batch, in which t is an integer greater than 1.

In an embodiment of the disclosure, in the process and equipment integrated digital twin system, the number of iterations is less than or equal to n times.

In an embodiment of the disclosure, in the process and equipment integrated digital twin system, an optimization algorithm of the dynamic parameter optimization is Bayesian optimization or genetic algorithm.

In an embodiment of the disclosure, in the process and equipment integrated digital twin system, the process production target includes a quality target and a production capacity target.

Based on the above, the process and equipment integrated digital twin method and system provided in the disclosure can simultaneously consider the interaction between the process and equipment. Since information such as equipment health status, process recipe, and quality target affects optimal process parameters, by integrating equipment health prediction and quality prediction, an integrated digital twin model of process and equipment can be established, and using process parameters recommended by the model can simultaneously improve product quality and production line efficiency, enhancing the production competitiveness of manufacturers.

In order to make the disclosure more comprehensible, embodiments are given below and described in detail with reference to the accompanying drawings.

### BRIEF DESCRIPTION OF THE DRAWINGS

FIG. 1 is a flow chart of a process and equipment integrated digital twin method of the disclosure.

FIG. 2 is a schematic diagram of a process and equipment integrated digital twin system of the disclosure.

FIG. 3 is a schematic diagram of factors affecting an optimal process parameter of the disclosure.

FIG. 4 is a schematic diagram of the modules and output used when executing the process and equipment integrated digital twin method of the disclosure.

FIG. 5 is a schematic diagram of the application of the process and equipment integrated digital twin method of the disclosure.

FIG. 6 is a schematic diagram of determining a process to be used currently through future health estimation and quality estimation of the disclosure.

FIG. 7 is an example diagram of data training data of the disclosure.

FIG. 8 is a schematic diagram of the integrated digital twin model training module of the disclosure.

FIG. 9 is a schematic diagram of the optimization flow of the process of the disclosure.

### DETAILED DESCRIPTION

Reference will now be made in detail to the exemplary embodiments of the disclosure, examples of the embodiments are illustrated in the accompanying drawings. The terms “first” and “second” mentioned in the full text of the specification of the disclosure (including the appended claims) are used to name elements or to distinguish different embodiments or scopes. The terms are not used to limit the upper limit or lower limit of the number of elements, nor are the terms used to limit the order of the elements. In addition, wherever possible, elements/components with the same reference signs are used in the drawings and embodiments to represent the same or similar parts.

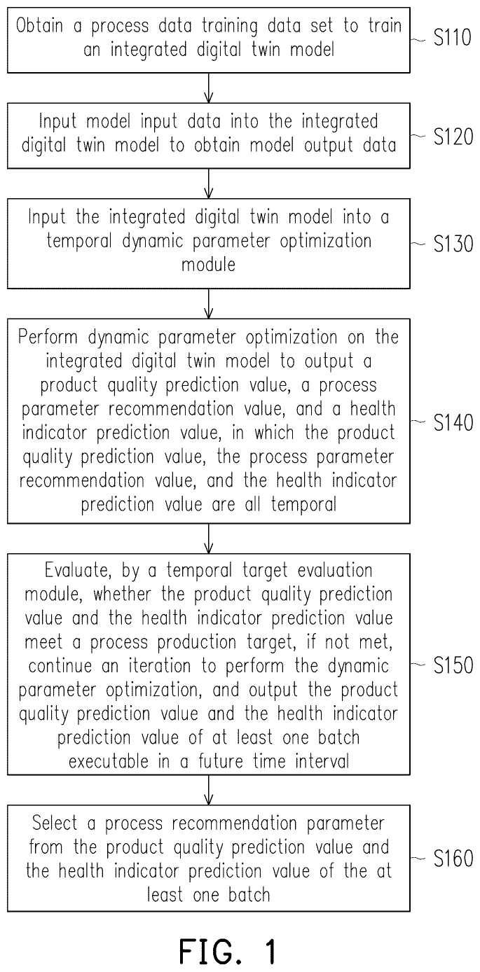

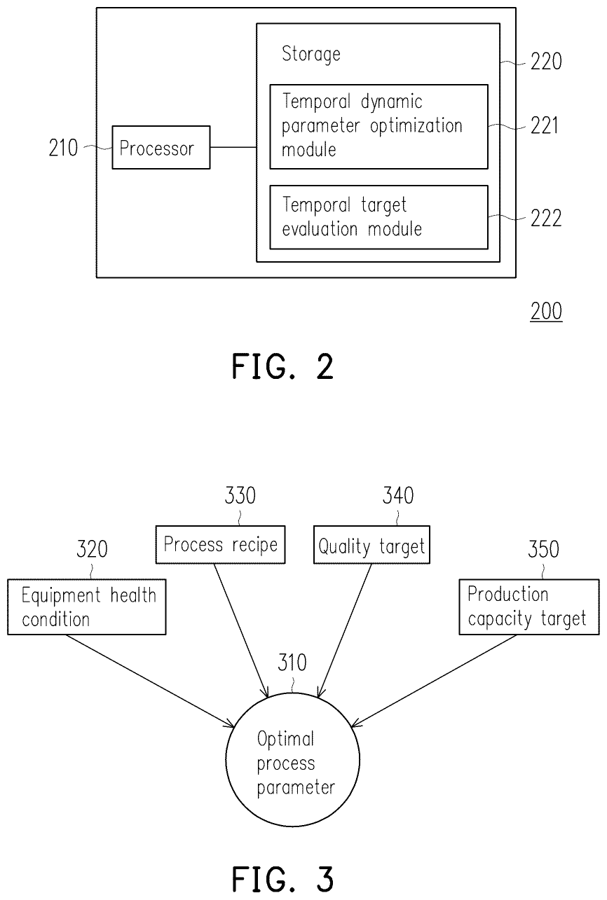

FIG. 1 is a flow chart of a process and equipment integrated digital twin method of the disclosure. In FIG. 1, each flow may be executed by a processor 210 in FIG. 2. In Flow S110, the processor 210 may obtain a process data training data set to train an integrated digital twin model. In Flow S120, the processor 210 may input model input data into the integrated digital twin model to obtain model output data. In Flow S130, the processor 210 may input the integrated digital twin model into a temporal dynamic parameter optimization module. In Flow S140, the processor 210 may perform dynamic parameter optimization on the integrated digital twin model to output a product quality prediction value, a process parameter recommendation value, and a health indicator prediction values, in which the product quality prediction value, the process parameter recommendation value, and the health indicator prediction value are all temporal. In Flow S150, the processor 210 may evaluate, by a temporal target evaluation module, whether the product quality prediction value and the health indicator prediction value meet a process production target, if not met, then an iteration is continued to perform the dynamic parameter optimization, and the product quality prediction value and the health indicator prediction value of at least one batch executable in a future time interval is output. In Flow S160, the processor 210 may select a process recommendation parameter from the product quality prediction value and the health indicator prediction value of the at least one batch.

FIG. 2 is a schematic diagram of a process and equipment integrated digital twin system of the disclosure. A process and equipment integrated digital twin system 200 may include the processor 210 and a storage 220.

In the embodiment of the disclosure, the processor is, for example, a central processing unit (CPU), or other programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable gate array (FPGA), or other similar components or a combination of the above components. In the process and equipment integrated digital twin system 200, the processor 210 may be coupled to the storage 220, and the processor 210 may execute each module stored in the storage 220.

The storage 220 is, for example, any type of fixed or removable random access memory (RAM), read-only memory (ROM), flash memory, hard disk drive (HDD), solid state drive (SSD), or similar components or a combination of the above components, and is used to store multiple modules or various applications executable by the processor 110. In the embodiment, the storage 220 may store at least a temporal dynamic parameter optimization module 221 and a temporal target evaluation module 222.

Referring to FIG. 3, FIG. 3 is a schematic diagram of factors affecting an optimal process parameter of the disclosure. In the embodiment of the disclosure, in order to obtain an optimal process parameter 310, the processor 210 needs to consider an equipment health condition 320, a process recipe 330, a quality target 340, and a production capacity target 350 at the same time.

Specifically, in order to train the integrated digital twin model, the processor 210 first needs to obtain the process data training data set. The process data training data set at least includes at least one process parameter, at least one product quality, and at least one equipment health indicator of the machine or equipment of the process. In other words, in the process data training data set, the fields at least include the parameter required for the process, the quality of the product produced, and the health indicator of the equipment. In the embodiment, the process at least includes recipe information. In the embodiment, the equipment health indicator is related to a sensor parameter of an equipment health condition. For example, each piece of equipment may be equipped with a self-detection device of the machine to provide the user with knowledge of whether any parts of the equipment or machine are damaged and need to be repaired. In other embodiments of the disclosure, the processor 210 may obtain a characteristic of the equipment health indicator through the health indicator extraction technology.

In the embodiment of the disclosure, in addition to the foregoing field items of the process data training data set, the fields of the process data training data set may further include the quality target of the product produced and the production capacity target, in this way, while taking into account the equipment health condition and the process recipe, quality optimization of the product and optimization of production capacity efficiency can also be achieved.

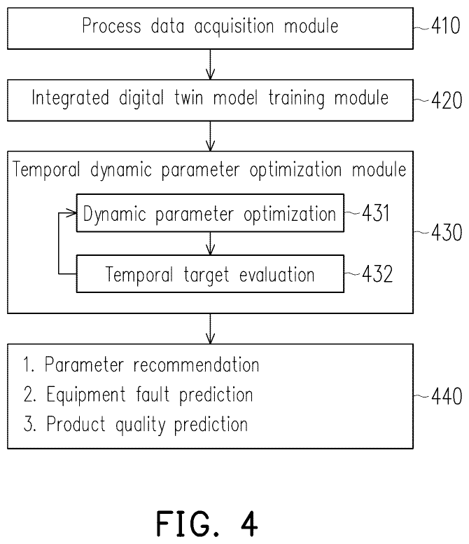

Please refer to FIG. 4. FIG. 4 is a schematic diagram of the modules and output used when executing the process and equipment integrated digital twin method of the disclosure. In the embodiment of the disclosure, the processor 210 first executes a process data acquisition module 410 to obtain the process data training data set. Next, the processor 210 may execute the integrated digital twin model training module to train the integrated digital twin model. The processor 210 may establish the integrated digital twin model through a machine learning algorithm, and the integrated digital twin model may include an equipment health condition prediction model and a quality prediction model. In other words, the integrated digital twin model can simultaneously consider predictions of the equipment health condition and the quality of output products.

In an embodiment of the disclosure, the machine learning algorithm may include support vector machine (SVM), random Forest (RF), and deep neural network (DNN). Since the machine learning algorithm needs to consider both the equipment health condition and the quality of the output product, the machine learning algorithm further needs to be combined with multi-task learning technology for modeling.

In other embodiments of the disclosure, the machine learning algorithm may also be a cascade model based on the actual process flow, multiple parameters that may affect equipment health and output quality are obtained from process parameters to establish and train the integrated digital twin model.

Returning to FIG. 4, since the embodiment of the disclosure needs to consider both the health condition of the equipment and the quality of the product, and after the equipment is used, parts may wear out due to the passage of time, which affects the health of the equipment, so the health condition of the equipment involves a temporal aspect. Moreover, since the health condition of the equipment also affects the product quality and output efficiency from different processes, it is necessary to evaluate the impact of the process parameter on the equipment health condition and the product quality in a temporal manner. When the processor 210 executes the temporal dynamic parameter optimization module 430, the processor 210 may perform dynamic parameter optimization 431 on parameters of the process to dynamically adjust the process parameters according to different times. In addition, due to the dynamic adjustment of the process parameters, the processor 210 further needs to evaluate the process parameter required for the equipment health condition after a period of time of manufacturing or production through temporal target evaluation 432, in order to achieve the target quality of the output product. It should be understood that the dynamic parameter optimization 431 and the temporal target evaluation 432 in the disclosure may be executed in a cyclic manner to obtain an optimal process recipe.

Referring to FIG. 4 still, after the processor 210 executes the temporal dynamic parameter optimization module 430, the processor 210 may output parameter recommendation, equipment fault prediction, and product quality prediction. Specifically, the processor 210 ultimately needs to recommend recipe parameters of the process to the user for use in the process. In addition, since the user may directly produce the product using the recipe recommended by the processor 210, the processor 210 may further predict the likelihood of equipment failure and product quality prediction if the user produces the product according to the process, thereby providing the user with a basis for deciding whether to produce products by using the recipe.

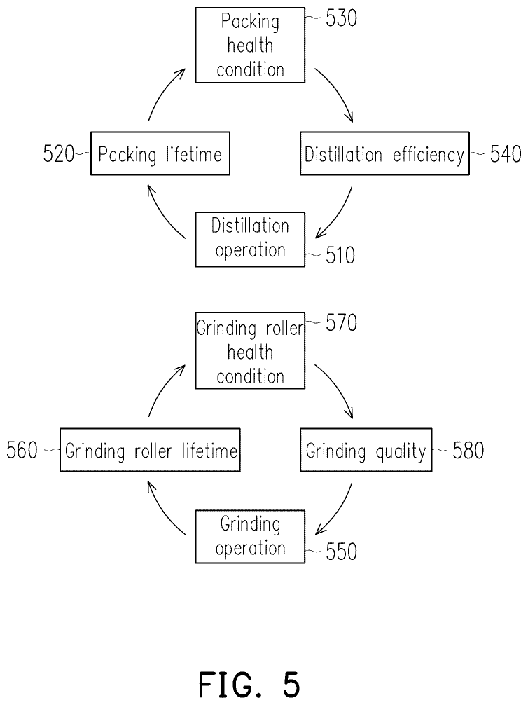

Please refer to FIG. 5. FIG. 5 is a schematic diagram of the application of the process and equipment integrated digital twin method of the disclosure. The process and equipment integrated digital twin method may be used, for example, in chemical processes or in the use of processing machines. Taking the chemical process as an example, distillation operation 510 is an example. The process equipment of distillation is mainly a distillation tower. The inside of the distillation tower is formed by many packings. A packing health condition 530 (the health status of the packing) affects a distillation efficiency 540, and the method of the distillation operation 510 affects a packing lifetime 520 (the service life of the packing). Therefore, by performing the distillation operation through the process recipe recommended by the process and equipment integrated digital twin method of the disclosure, the process and equipment integrated digital twin method can also predict the packing lifetime and distillation performance at the same time.

Referring to FIG. 5 still, taking the use of processing tools as an example, grinding operation 550 is an embodiment. The equipment of the grinding machine is mainly a grinding machine, in which the key part is the grinding roller. A grinding roller health condition 570 affects a grinding quality 580, and the setting of the grinding operation 550 affects a grinding roller lifetime 560. Therefore, by performing the grinding operation through the process recipe recommended by the process and equipment integrated digital twin method of the disclosure, the process and equipment integrated digital twin method can also predict the grinding roller lifetime and grinding quality at the same time.

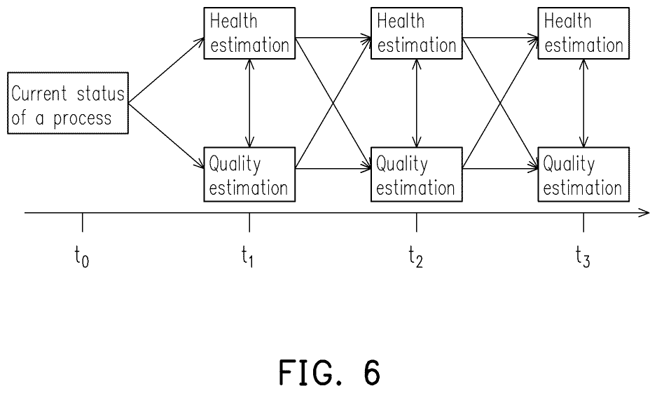

Please refer to FIG. 6. FIG. 6 is a schematic diagram of determining a process to be used currently through future health estimation and quality estimation of the disclosure. Specifically, a time t₀ is the time when product production needs to be carried out at the current stage. If the process parameters recommended by the process and equipment integrated digital twin method are used to produce products, then the processor 210 may estimate the health status of the equipment and the estimation of the product quality at a time t₁. It should be understood that at the time t₁, the health status of the equipment and the product quality also have an interactive relationship and thus influence each other.

Referring to FIG. 6 still, when a process recipe for the time t₁ is obtained using the health status of the equipment and the estimation of the product quality at the time t₁, and the processor 210 executes the process recipe, the operation affects the health status of the equipment and the estimation of the product quality at a time t₂, and further affects a process recipe for the time t₂. The health status of the equipment and the estimation of the product quality subsequently at a time t₃ are also affected by the process recipe for the time t₂, which in turn allows the process and equipment integrated digital twin method to recommend a process recipe for the time t₃.

Following the above, since executing the process parameters obtained at the time t₀ may affect the subsequent equipment health and product quality, and the process and equipment integrated digital twin method may predict equipment health and product quality at each time point in the future time period, the user may decide whether to execute the current process parameters based on the prediction result. If the user believes that the equipment health and the product quality in the subsequent period affected by the current process parameters are not as expected, for example, the user expects that the equipment parts only need to be replaced after 10 process cycles are executed, but the prediction result shows that the equipment parts are no longer usable after 8 process cycles are executed, then the processor 210 may iteratively execute the temporal dynamic parameter optimization module 430 to recommend a process that ensures the equipment parts meet the expectation of the user and only need to be replaced after 10 process cycles are executed. Therefore, the estimation of future equipment health and the estimation of product quality affect the current decision of the user to execute the process parameters recommended by the processor 210. It should be understood that there is an upper limit for the number of times the processor 210 iteratively execute the temporal dynamic parameter optimization module 430 to prevent the processor 210 from being unable to recommend process parameters that meet the expectation of the user when the equipment is too old. The upper limit of the number of iterations is, for example, 50 times. Implementers of the disclosure may adjust the upper limit of the number of iterations according to actual applications.

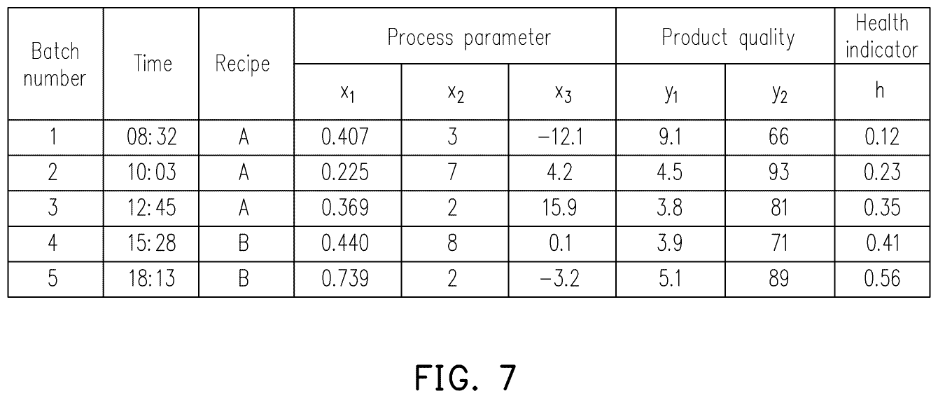

Please refer to FIG. 7. FIG. 7 is an example diagram of data training data of the disclosure, which may be used as a data diagram corresponding to the process parameters, the product qualities, and the equipment health indicator corresponding to a single time in the iterative process in FIG. 6. As shown in FIG. 7, if the user uses a recipe A recommended by the process and equipment integrated digital twin method at a first time of 08:32, then the process parameters x₁, x₂, and x₃ are 0.407, 3, and −12.1 respectively, the output product quality parameters y₁ and y₂ are 9.1 and 66 respectively, and the final equipment health indicator h is 0.12.

Following the above, since the user uses the process of the recipe A for the first time of 08:32, subsequently at a second time of 10:03, by using the recipe A, the process parameters x₁, x₂, and x₃ are 0.225, 7, and 4.2 respectively, the quality parameters y₁ and y₂ are 4.5 and 93 respectively, and the health indicator is 0.23; at a third time of 12:45, by using the recipe A, the process parameters x₁, x₂, and x₃ are 0.369, 2, and 15.9 respectively, the quality parameters y₁ and y₂ are 3.8 and 81 respectively, and the health indicator is 0.35; at a fourth time of 15:28, by using a recipe B, the process parameters x₁, x₂, and x₃ are 0.440, 8, and 0.1 respectively, the quality parameters y₁ and y₂ are 3.9 and 71 respectively, and the health indicator is 0.41; and at a fifth time of 18:13, by using the recipe B, the process parameters x₁, x₂, and x₃ are 0.739, 2, and −3.2 respectively, the quality parameters y₁, y₂ are 5.1 and 89 respectively, and the health indicator is 0.59, which is the result that occurs if the user continues to use the recipe recommended by the process and equipment integrated digital twin method. Therefore, it may be inferred that if the user uses the recipe A, after the fifth execution, the health indicator of the equipment is 0.56.

It may be seen from the above content in FIG. 7 that when the model inputs historical process parameters of a t-th batch, a historical equipment health indicator of a (t-1)-th batch, and historical product qualities of the (t-1)-th batch, the model output data at least includes product qualities of the t-th batch and equipment health indicators of the t-th batch, in which t is an integer greater than 1.

In the embodiment of the disclosure, since the ultimate target of using the process recommendation parameters recommended by the process and equipment integrated digital twin method is to improve quality of the product and increase the production capacity, the process production target includes a quality target and a production capacity target. Additionally, on the basis of the above, the extension of equipment service life can also be pursued.

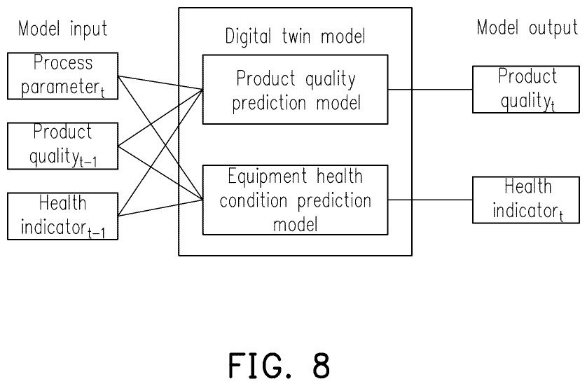

Please refer to FIG. 8. FIG. 8 is a schematic diagram of the integrated digital twin model training module of the disclosure. The digital twin model includes a product quality prediction model and an equipment health condition prediction model. When a process parameter t, a product quality t-1, and a health indicator t-1 are input into the model, the model may output to obtain a product quality t and a health indicator t. Also, the flow may be executed repeatedly to finally obtain the product quality and the equipment health indicator after repeated execution within a time interval. As may be seen from FIG. 8, after the currently used process parameter, the previous product quality, and the previous equipment health indicator are input into the digital twin model, the parameters affect the product quality prediction model and the equipment health condition prediction model respectively. That is to say, in the embodiment of the disclosure, the product quality and the equipment health condition interact with each other.

In an embodiment of the disclosure, an optimization algorithm used in the dynamic parameter optimization process may be Bayesian optimization or genetic algorithm.

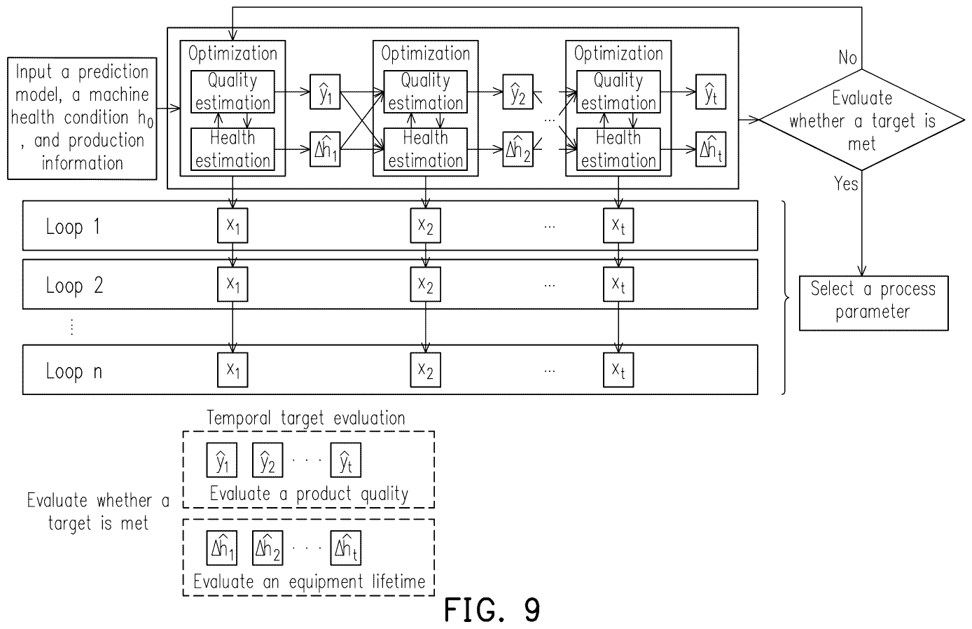

Please refer to FIG. 9. FIG. 9 is a schematic diagram of the optimization flow of the process of the disclosure. In FIG. 9, firstly, the prediction model, the machine health condition, and the production information are input into the digital twin model for dynamic parameter optimization. The product quality estimation and the equipment health condition estimation obtained after a first optimization are obtained as ŷ₁ and Δĥ₁ respectively. After performing a second optimization to ŷ₁ and Δĥ₁, the product quality estimation and the equipment health condition estimation may be obtained as ŷ₂ and Δĥ₂ respectively. Also, after t iterations, ŷₜ and Δĥₜ may finally be obtained. At this time, the processor 210 may perform temporal target evaluation of product quality for ŷ₁ ŷ₂ . . . ŷₜ. For example, the processor 210 may estimate the product quality each time to confirm that the product quality meets expectations. In addition, the processor 210 may perform temporal target evaluation of equipment lifetime for Δĥ₁Δĥ₂Δĥₜ. For example, the processor 210 may estimate the equipment health condition after each execution of the process to confirm that the equipment health condition meets expectations.

Following the above, the operation in which the processor 210 estimates the product quality and estimates the equipment lifetime is referred to as one cycle. The above operation is referred to as a Loop 1. If the processor 210 determines that the target is not met after the cycle ends, for example, max(ŷᵢ) is not less than 5 (i is 1, 2 . . . t), in which max is the maximum value; or mean(Δĥᵢ) is not less than 0.1 (i is 1, 2 . . . t), in which mean is the average, then the processor 210 executes the next iteration and enters a Loop 2. At this time, with the data of the Loop 1, the processor 210 may add the data of the Loop 1 back to the input of the prediction model to perform the computation of the Loop 2. Assuming that the processor 210 evaluates that the target is still not met after the Loop 2, then the processor 210 may continue to the next round of iteration, and the iteration may be carried out for n times (including but not limited to, the maximum value of n is 50) and then ends.

If the processor 210 evaluates that the target is still not met after executing the Loop for n times, the processor 210 may determine that the parts or packings of the equipment are excessively worn and cannot be used. However, if the user still wants to perform the process, then the processor 210 may select the process parameter obtained from a cycle that best meets the product quality and the equipment health as the process parameter among the n cycles. The condition of best meeting the product quality and the equipment health as mentioned above may be, for example, the user may prioritize that max(ŷᵢ) is less than 5 in a case of the product quality being more emphasized. Implementers of the disclosure may adjust the selection method of process parameters according to actual needs.

The disclosure further provides a computer program product, which includes a computer program. The processing performed by the process and equipment integrated digital twin system 200 in the disclosure is prepared, for example, as an application software or other program. That is, implementing the program of the embodiment may be understood as using a computer to implement a program with the following functions: obtaining a process data training data set to train an integrated digital twin model; inputting model input data into the integrated digital twin model to obtain model output data; inputting the integrated digital twin model into the temporal dynamic parameter optimization module; performing dynamic parameter optimization on the integrated digital twin model to output the product quality prediction value, the process parameter recommendation value, and the health indicator prediction value, in which the product quality prediction value, the process parameter recommendation value, and the health indicator prediction value are all temporal, evaluating, by the temporal target evaluation module, whether the product quality prediction value and the health indicator prediction value meet the process production target, if not met, continuing the iteration to perform the dynamic parameter optimization, and outputting the product quality prediction value and the health indicator prediction value of at least one batch executable in a future time interval; and selecting a process recommendation parameter from the product quality prediction value and the health indicator prediction value of the at least one batch.

In summary, the process and equipment integrated digital twin method and system provided in the disclosure can simultaneously consider the interaction between the process and equipment. Since information such as equipment health status, process recipe, and quality target affects optimal process parameters, by integrating equipment health prediction and quality prediction, an integrated digital twin model of process and equipment can be established, and using process parameters recommended by the model can simultaneously improve product quality and production line efficiency, enhancing the production competitiveness of manufacturers.

What is claimed is:

1. A process and equipment integrated digital twin method, comprising:
obtaining a process data training data set to train an integrated digital twin model;
inputting a model input data into the integrated digital twin model to obtain a model output data;
inputting the integrated digital twin model into a temporal dynamic parameter optimization module;
performing a dynamic parameter optimization on the integrated digital twin model to output a product quality prediction value, a process parameter recommendation value, and a health indicator prediction value, wherein the product quality prediction value, the process parameter recommendation value, and the health indicator prediction value are all temporal;
evaluating, by a temporal target evaluation module, whether the product quality prediction value and the health indicator prediction value meet a process production target, if not met, continuing an iteration to perform the dynamic parameter optimization, and outputting the product quality prediction value and the health indicator prediction value of at least one batch executable in a future time interval; and
selecting a process recommendation parameter from the product quality prediction value and the health indicator prediction value of the at least one batch.

2. The process and equipment integrated digital twin method as claimed in claim 1, wherein the process data training data set comprises at least one process parameter, at least one product quality, and at least one equipment health indicator of a machine or equipment of a process,
wherein the equipment health indicator is related to a sensor parameter of an equipment health condition or a characteristic obtained through health indicator extraction technology.

3. The process and equipment integrated digital twin method as claimed in claim 2, wherein the process comprises a recipe information.

4. The process and equipment integrated digital twin method as claimed in claim 1, further comprising:
establishing the integrated digital twin model through a machine learning algorithm, wherein the integrated digital twin model comprises an equipment health condition prediction model and a quality prediction model.

5. The process and equipment integrated digital twin method as claimed in claim 4, wherein the machine learning algorithm comprises support vector machine (SVM), random Forest (RF), and deep neural network (DNN), and is combined with multi-task learning technology for modeling; or the machine learning algorithm is a cascade model based on an actual process flow.

6. The process and equipment integrated digital twin method as claimed in claim 1, wherein the model input data at least comprises a historical process parameter of a t-th batch, a historical equipment health indicator of a (t-1)-th batch, and a historical product quality of the (t-1)-th batch and the model output data at least comprises a product quality of the t-th batch and an equipment health indicator of the t-th batch, wherein t is an integer greater than 1.

7. The process and equipment integrated digital twin method as claimed in claim 6, wherein the number of iterations is less than or equal to n times.

8. The process and equipment integrated digital twin method as claimed in claim 1, wherein an optimization algorithm of the dynamic parameter optimization is Bayesian optimization or genetic algorithm.

9. The process and equipment integrated digital twin method as claimed in claim 1, wherein the process production target comprises a quality target and a production capacity target.

10. A process and equipment integrated digital twin system, comprising:
a storage storing a plurality of modules; and
a processor coupled to the storage, and configured to:
obtain a process data training data set to train an integrated digital twin model;
input a model input data into the integrated digital twin model to obtain a model output data;
input the integrated digital twin model into a temporal dynamic parameter optimization module among the plurality of modules;
perform a dynamic parameter optimization on the integrated digital twin model to output a product quality prediction value, a process parameter recommendation value, and a health indicator prediction value, wherein the product quality prediction value, the process parameter recommendation value, and the health indicator prediction value are all temporal;
evaluate, by a temporal target evaluation module among the plurality of modules, whether the product quality prediction value and the health indicator prediction value meet a process production target, if not met, continue an iteration to perform the dynamic parameter optimization, and output the product quality prediction value and the health indicator prediction value of at least one batch executable in a future time interval; and
select a process recommendation parameter from the product quality prediction value and the health indicator prediction value of the at least one batch.

11. The process and equipment integrated digital twin system as claimed in claim 10, wherein the process data training data set comprises at least one process parameter, at least one product quality, and at least one equipment health indicator of a machine or equipment of a process, wherein the equipment health indicator is related to a sensor parameter of an equipment health condition or a characteristic obtained through health indicator extraction technology.

12. The process and equipment integrated digital twin system as claimed in claim 11, wherein the process comprises a recipe information.

13. The process and equipment integrated digital twin system as claimed in claim 10, wherein the processor is further configured to:
establish the integrated digital twin model through a machine learning algorithm, wherein the integrated digital twin model comprises an equipment health condition prediction model and a quality prediction model.

14. The process and equipment integrated digital twin system as claimed in claim 13, wherein the machine learning algorithm comprises support vector machine, random forest, and deep neural network, and is combined with multi-task learning technology for modeling; or the machine learning algorithm is a cascade model based on an actual process flow.

15. The process and equipment integrated digital twin system as claimed in claim 10, wherein the model input data at least comprises a historical process parameter of a t-th batch, a historical equipment health indicator of a (t-1)-th batch, and a historical product quality of the (t-1)-th batch and the model output data at least comprises a product quality of the t-th batch and an equipment health indicator of the t-th batch, wherein t is an integer greater than 1.

16. The process and equipment integrated digital twin system as claimed in claim 15, wherein the number of iterations is less than or equal to n times.

17. The process and equipment integrated digital twin system as claimed in claim 10, wherein an optimization algorithm of the dynamic parameter optimization is Bayesian optimization or genetic algorithm.

18. The process and equipment integrated digital twin system as claimed in claim 10, wherein the process production target comprises a quality target and a production capacity target.
